(19) United States
(12) Patent Application Publication
(10) Pub. No.: US 2009/0321333 A1
(43) Pub. Date: Dec. 31, 2009

(54) COOKING OIL FILTERING SYSTEM APPARATUS AND SYSTEM

(76) Inventor: Charles T. Magliocca, Yuma, WA (US)

Correspondence Address: HUGHES LAW FIRM, PLLC, 5160 Industrial Place,#107, Ferndale, WA, 98248-7819, US

(21) Appl. No.: 12/345,446

(22) Filed: Dec. 29, 2008

Related U.S. Application Data
(60) Provisional application No. 61/016,781, filed on Dec. 26, 2007.

(51) Int. Cl. B01D 21/26; A23D 9/00

(52) U.S. Cl. 210/167.28; 426/490

(57) ABSTRACT

A cooking oil filtering system to extract cooking oil from a reservoir and direct it an enclosed centrifugal filter. The oil which is passed through the centrifugal filter is then directed back to the reservoir. The centrifugal filter is powered by a turbine which in turn is powered by a portion of the cooking oil which is delivered by a pump to the centrifugal filter. There is an oil supply and return section where there is an inlet hose having an end inserted in the oil of the reservoir and is connected to a pump which in turn directs the oil to the housing in which the second centrifugal filter is retained. The oil that is directed to power of the turbine and also to pass through the centrifugal filter is directed to a drain that in turn connects to hose which returns the cooking oil to the reservoir.

### RELATED APPLICATIONS

This application claims priority benefit of U.S. Ser. No. 61/016,781, filed Dec. 26, 2007.

### BACKGROUND OF THE DISCLOSURE

a) Field of the Invention

The present invention relates to the treatment of cooking oils to remove fragments of food and other material that may collect in the oil and other undesirable material that may be deposited in or developed in the oil.

b) Background Art

It is quite common in restaurants or fast food operations to cook potatoes in cooking oil to provide “French-fried” potatoes or cook other food products in the oil. It is a practice to periodically filter the cooking oil to remove particles which remain in the cooking oil or simply unwanted material which forms in the cooking oils after a period of time.

In some established restaurants, the cooking oil is filtered in an automatic process where the cooking oil is discharged from the reservoir or cooking chamber to be passed through a filter or filters and then returned back to the reservoir or other containment member for the cooking oil.

In other instances, in a small restaurant operation where there may be only one or two cooking oil stations, there has been a practice of removing the oil from its oil cooking chamber and feeding it through a filter and then returning it to its cooking container. Unfortunately, the cooking oil can be rather hot and if it comes into contact with a person's skin, it can cause severe burns. Thus, in the handling of these cooking oils where they are taken from the container regions, accidents can and do occur.

### SUMMARY OF THE DISCLOSURE

There is a cooking oil centrifuge filtering section which is enclosed in a filtering chamber. There is also an oil feeding section having a conduit with an inlet that is placed in the cooking oil. The cooking oil is sucked into the conduit and directed to the oil filtering apparatus where it passes through its centrifugal filter. The filtered oil is removed from the chamber by directing it through a return tube or hose back to the reservoir or other container from which the cooking oil was taken. In this process the oil is totally isolated within the conduits and chamber and is only exposed to the outside atmosphere when it is in the reservoir or other container from which it is taken.

### BRIEF DESCRIPTION OF THE DRAWINGS

FIG. 1 is an elevational view, partly in section, showing a first embodiment of the oil filtrating system of a first embodiment;

FIG. 2 is a somewhat schematic drawing showing the various components of the system of a second embodiment;

FIG. 3 is a view very similar to FIG. 2, but with an inlet hose portion of the system being moved to another location;

FIG. 4 is a top plan view showing the filter section of the system being positioned in a laterally facing position;

FIG. 5 is a rear view of the same components shown in FIG. 4;

FIG. 6 is a view similar to FIG. 4 but with the filter section in a more retracted position;

FIG. 7 is a top plan view of the apparatus with the filter section having been moved to a stowed position;

FIG. 8 is an elevational view of the components of the system in a stowed position;

FIG. 9 is a view where the filter section is moved to a higher elevation so that it is able to operate in a location where the reservoir is at a higher elevation;

FIG. 10 is an isometric view of the assembly of a third embodiment of the present invention;

FIG. 11 is a side elevational view showing the support section carrying the filter section at an elevated operating position;

FIG. 12 is a top plan view of the apparatus of FIG. 11, but showing in addition just a smaller component of the oil supply system;

FIG. 13 is a sectional view taken at the line A-A of FIG. 11;

FIG. 14 is a view showing primarily the support section of this third embodiment;

FIG. 15 is a sectional view taken at B-B of FIG. 14; and

FIG. 16 is a sectional view taken along line C-C of FIG. 14, and showing a turbine in the filter section.

### DESCRIPTION OF THE PREFERRED EMBODIMENTS

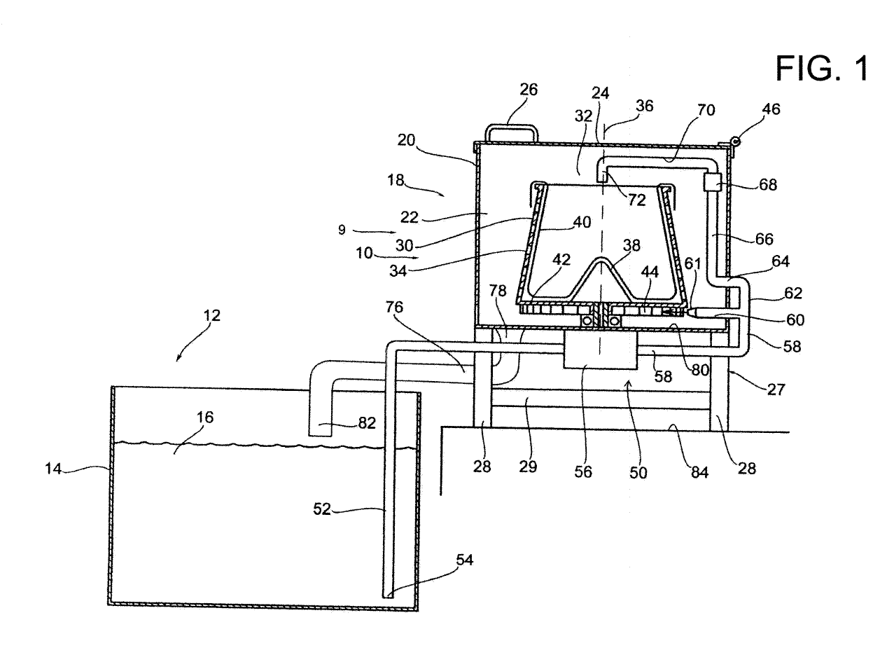

FIG. 1 shows a first embodiment of the present invention in the form of an assembly 9 of a cooking oil filtering apparatus 10, and a cooking oil supply and return section 50 (to be described later).

A major portion of the apparatus is shown in a transverse cross-section passing through a center axis of rotation 36 of one of its main components. Also, to the left of the oil filtering apparatus in FIG. 1, there is shown a source 12 of cooking oil in the form of a reservoir 14, shown in section, and containing a quantity of cooking oil 16 which is being processed in the apparatus 10. This reservoir 14 could be, for example, a reservoir of hot cooking oil 16 in a restaurant that provides French-fried potatoes.

In FIG. 1, there is shown a centrifugal filtering section 18 which comprises a centrifugal filtering housing 20 which in turn defines a filtering chamber 22. To close the chamber 22 there is a lid 24 having a handle 26 by which it can swing about a hinge to an open position.

The entire filter section 18 is positioned on a support frame 27 that in turn comprises a pair of legs 28 and a cross-member 29.

A centrifuge filter 30 is positioned in the chamber 22 that is defined by the housing 20. This centrifuge filter 30 has the configuration of a truncated cone with the smaller part of the truncated cone being at an upper part of the centrifuge filter 30 and the expanded part of the centrifuge filter 30 being at a lower position in the housing chamber 22.

The centrifuge filter 30 comprises a perforated sidewall 34, having an upper centrally located open inlet 32, and it has a vertical central axis of rotation 36. The bottom wall of the centrifuge filter 30 may have a lower raised central portion 38 to deflect the descending oil outwardly toward the outer surrounding perforated wall of the centrifuge. Also, there is a removable filter member 40 which is positioned in the interior of the centrifuge filter 30 so as to be pressed against the inside surface of the perforated sidewall 34. This filter member 40 can be made of a flexible paper-like filter material, and it can be readily inserted in, and removed from, the inside portion of the centrifuge filter 30. Connected to the bottom part of the centrifuge 30 is a turbine 42, comprising a plurality of turbine blades 44.

For convenience in describing the filtering system 10, that part of the filtering section 18 shown in FIG. 1 that is closest to the reservoir 14 shall be considered to be a forward portion of the filtering section 18, and the opposite side is to be considered the rearward portion. The aforementioned lid 24 has a rear-hinge connection 46 at an upper rear-edge portion of the back wall of the housing 20. This enables the lid 24 to be lifted periodically to remove the filter 40 with the food fragments and other material that would be collected in the filter in the centrifuge operation.

As indicated earlier, the assembly 9 comprises a cooking oil supply and return section 50, and is part of the entire system 9. The supply portion of this section 50 comprises an inlet hose 52 that has an inlet 54 which is positioned at a lower location in the reservoir 14. There is a pump 56 that is connected to the opposite end of the hose 52 and draws the cooking oil 16 from the reservoir 10 and then directs the oil into an outlet tube 58. This tube 58 directs the cooking oil into two different branch locations. More specifically, the outlet tube 58 directs part of the cooking oil into a first lower branch 60 which extends through a sidewall of the housing 20 and directs a stream of the cooking oil through a nozzle 61 against the aforementioned turbine blades 44 to cause the rotation of the turbine 42 to in turn rotate the centrifuge 30.

The outlet tube 58 continues on at 62 from the first lower branch 60 upwardly to supply oil to a second branch 64 that extends through the rear wall of the housing 20 and has an upturned conduit portion 66 extending upwardly, and its upper end engages a swivel joint 68. Connected to the swivel joint 68 is a horizontally extending discharge arm 70 which is shown in the attached drawing as having an outlet 72 which is above the centrifuge inlet 32. This discharge arm 70 can be moved from its operating position in the attached FIG. 1 and moved laterally to be positioned against the sidewall of the housing 20 to permit a person to insert or to remove the removable filter member 40 from its position inside the centrifuge filter 30.

Also the pump 56 may be in the form of a motor/pump combination with the motor driving the pump and also having a drive connection to the centrifuge filter 30. In that configuration the turbine 42 would not be needed, nor would the branch tube portion be needed.

As indicated earlier, there is a handle 26 connected to the upper front portion of the lid 24 so that the lid 24 can easily be lifted to rotate about the hinge connection 46 so that the dispensable filter member 40 can easily be removed from the centrifuge filter 30 and a fresh filter member can be inserted in the centrifuge filter 30.

As part of the return portion of the supply and return section 50, there is a drain outlet tube 76 having a drain inlet 78 which is at the location of the floor 80 of the centrifugal filtering housing 20. The drain tube 76 then continues to an outlet location 82.

Thus, in operation, the cooking oil from the reservoir 14 is caused to flow through the inlet hose 52 through the pump 56 and then into the outlet tube 58. At this location, part of the oil is ejected through the outlet and through the discharge nozzle 61 to drive the turbine 42 which then rotates the centrifuge filter 30.

A second portion of the oil that is drawn in from the reservoir 14 is directed through the outlet 72 into the centrifuge chamber where it passes outwardly through the filter into the area within the outside of the centrifuge, but within the chamber 22 to drop down to the floor 80. Then the oil deposited on the floor 80 passes into the drain inlet 78 and through the drain conduit 76 to the drain outlet 82 to return to the reservoir 14.

With regard to the operation and method of this first embodiment of the present invention, let us assume that this oil cleaning unit is to be used in a restaurant or fast food environment where there is a fry section where French-fried potatoes and other food products are cooked in the oil 16 contained in the oil reservoir 14. At the end of the day, the usual routine would be to have a clean-up in the kitchen of the restaurant, etc. At this time, the entire portable filtering apparatus 10 could be placed on a kitchen platform in a position adjacent to the reservoir 12 as shown in the accompanying drawing.

Then the pump 56 would be attached to a source of electric power. The intake hose 52 would have its intake end 54 lowered into the cooking oil 16, and care would be taken that there is a filter 40 located in the centrifuge filter 30. Also, the drain outlet 82 would be located to discharge the oil into the reservoir 14.

Then the pump 56 is activated to draw the oil 16 out of the reservoir 14 and direct it into the outlet tube 58 so that part of the oil is directed through the first branch outlet 60 to be discharged from a nozzle 61 to drive the turbine 42, and this oil drops onto the floor of the housing 20. The rest of the oil is directed through the second branch tube 64 through the tube portion 66 to the swivel joint 68 and to the discharge arm 70 and through the outlet 72 to descend into the centrifuge filter 30. As the centrifuge filter 30 rotates, there is an outward flow of the oil through the filter 40 and also through the circumferential perforated sidewall 34 of the centrifuge filter 30 to drop onto the bottom of the housing 20.

Then both portions of the cooking oil are discharged onto the floor 80 in the chamber 20 will flow into the drain inlet 78 and then back through the drain tube 76 and out of the outlet 82 back into the reservoir 14. This is a continuous process, and as the oil 16 is withdrawn from the reservoir 14 and filtered in the filter section 18, at the same time the filtered oil is returned through the return conduit 76 back to the reservoir 14.

Thus, it can be seen that the cooking oil 16 in the reservoir 10 is not exposed to any outside environment, except that it is drawn out of the reservoir 14 to go through the filtering process and is returned through the drain outlet 82.

It has been found through building and developing a prototype of this embodiment that if there is a typical 5-gallon reservoir 16 of cooking oil, all of the 5-gallons would make the entire journey through the system in approximately one minute so that at the end of five minutes, a 5-gallon quantity of the cooking oil would pass through the apparatus five times.

Another significant advantage of this system of the present invention is that at all times, except for the cooking oil being exposed in the reservoir 14, the cooking oil is totally concealed within the apparatus of the present invention at all times, with the oil being contained either within the chamber 20 or in the flow paths of the various tubing. This substantially decreases the possibility of the person who is performing the operation of filtering the cooking oil from getting injured, such as coming into contact with the hot oil.

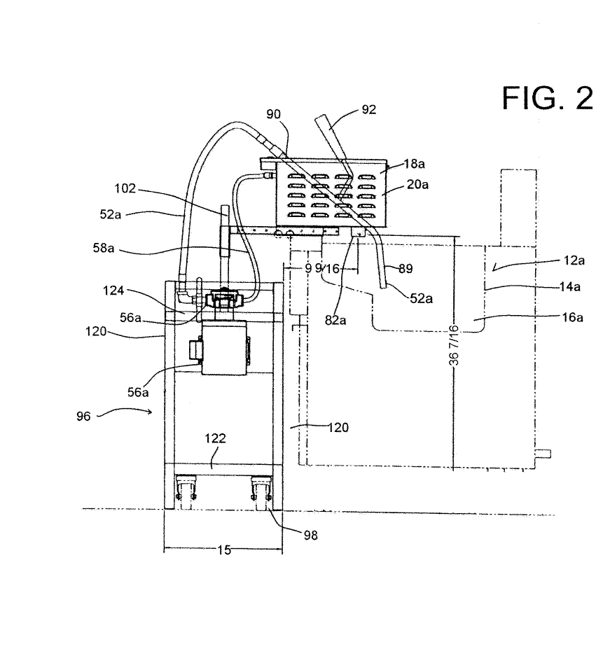

A second embodiment of the present invention will now be described with reference to FIGS. 2 through 9. This second embodiment contains all of the basic components of the first embodiment and also accomplishes substantially the same main objectives as in first embodiment. In this second embodiment, other features are added which relate to the overall ability to position and operate these embodiments.

In describing these next two embodiments, components of these next two embodiments which are the same as, or similar to, components of the first embodiment will be given like numerical designations, with an “a” suffix (or a “b” suffix in the third embodiment) to identify these as being related to the first embodiment.

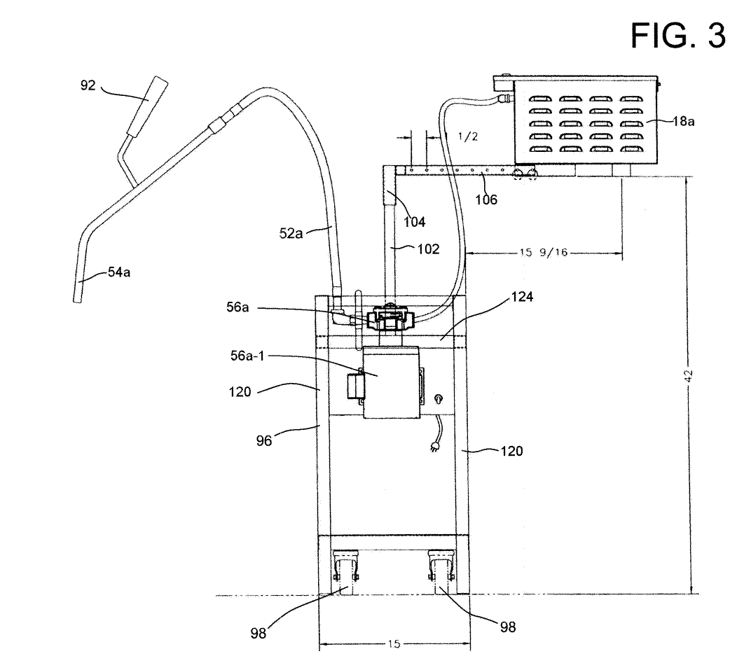

Reference is first made to FIG. 2 which is a side elevational view of the apparatus of this second embodiment. FIG. 3 is substantially the same as FIG. 2, with the only difference being that the rod 90 is moved over to the other side in FIG. 3 for ease of illustration in adding identifying numbers, etc. As indicated above, this second embodiment and the following third embodiment contain the basic components of the first embodiment, but have added other features. Accordingly, there will first be a brief review of those components which were present in the first embodiment and which are present in this second embodiment.

In the upper part of FIG. 2, there is shown the centrifugal filtering section 18a, which is (or may be) identical to the centrifugal filtering section 18 of the first embodiment. Also, there is a motor/pump component designated 56a to denote a motor/pump combined or as two separate components. There is an outlet tube 58a having an intake end connected to the pump 56a, and having its opposite outlet end connected to an inlet of the centrifugal filtering section 18a. Then one portion of oil is used to drive the turbine 42 (not shown in FIGS. 2 and 3), and another portion of the oil being fed into the centrifuge filter 30 (not shown in FIGS. 2 and 3). This oil settles onto the floor of the housing chamber 22a and then flows out of the drain 78a to return to the reservoir 14a.

In this second embodiment there is additional apparatus used in withdrawing the oil from the reservoir 14a. More specifically, there is a moderately stiff intake member 89 which is part of the inlet 52a and is connected through a tube 90 (part of inlet 52) to an inlet hose 52a which directs the cooking oil into the pump 56a powered by the motor also designated 56a. The tube 90 is connected to a handle 92, and the outlet portion 52a is at least moderately rigid. Thus, the handle 92 and the tube 90 are able to be manipulated so that a person could position the intake opening 54a at various locations in the reservoir 14a for various reasons.

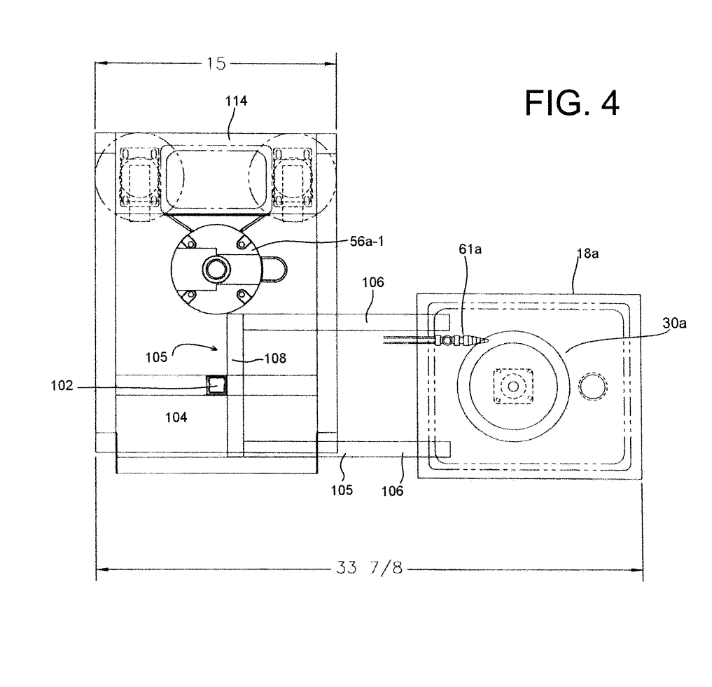

For example, there may be a particle of food which is moderately stuck inside the reservoir 14a, and this intake member 89 would be a means of dislodging the food particle and drawing it into the intake 54a. Also, there is a cooking oil drain 82a that discharges the cooking oil from the housing chamber (not shown) within the housing 20a. In FIG. 4 there is shown a small drip pan 114 which would support the member 89 to catch dripping oil in a stowage configuration. Also in FIG. 4 there is shown schematically two swivel casters 98.

This second embodiment also differs from the first embodiment in that the entire assembly is carried by a cart 96. There is a pair of wheels 98 for the cart 96 as shown in FIGS. 2 and 3.

FIG. 3 is substantially identical to FIG. 2. The only difference is cosmetic and is only the placement of the intake members 90 and 92 done for ease of description. Thus, there is shown in both FIGS. 2 and 3 some of the basic components such as the oil supplying and recovering system with a motor 56a-1, pump 56a, handle 92 and hose 52a, and also the various hookups to the filtering section 18a.

Beyond this there is also provided in this second embodiment a support system for the filtering section 18a which performs various functions. More specifically, this support system enables the filtering section 18a to be moved closer to or further away from the main part of the apparatus, and also rotated to face laterally or forwardly and also can be raised or lowered to different elevations. Also, the filtering section 18a can be moved to a front part of the cart 96, or it could be positioned in a location where it is immediately above the cart so as to be in its stowed position where it has a very small footprint. These various operations will be explained in the following text.

With further reference to FIG. 3, and to discuss in more detail the above mentioned functions, there is shown a vertical post 102 that has a lower end anchored to the underlying structure, and has a square cross-section. Then there is a short support sleeve 104 which has a square shaped interior so that it can slide up and down on the column 102. There is a horizontal support member 105 (FIG. 4) that is rigidly attached to the support sleeve 104.

The user of this apparatus can lift the support sleeve 104 and the filtering section 18a with its support platform upwardly to a sufficient height so that the support sleeve 104 is free of the post 102 and the support sleeve 104 can be rotated 90° or 180° to change direction, directly laterally outwardly from the cart 96, and also positioned so that is located over the cart for stowage.

It is to be understood that while this is accomplished by using the square shaped column 102 and the sleeve support member 104, this could be accomplished by other mechanical means which would be able to be raised or lowered, or also have the orientation changed to different directions.

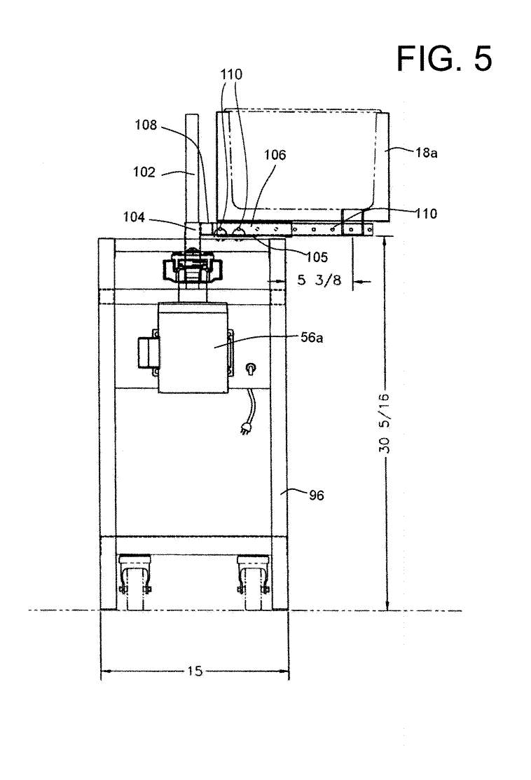

The support section which actually comes into engagement with the filtering section 18a can best be seen in FIGS. 4, 5 and 6. This comprises a horizontally aligned U-shaped horizontal support member 105 which is made up of a pair of parallel arms 106 with these being rigidly connected to a base cross-member 108. The filtering section 18a may slide along the arms 106 to be extended or retracted (see FIG. 5) and fixed in place with locking pins 110. This cross-member 108 is welded or otherwise bonded to the sleeve support member 104. Also in FIG. 4, there is indicated somewhat schematically the centrifuge 30a and the nozzle 61a to demonstrate pictorially that this is the filtering section 18a.

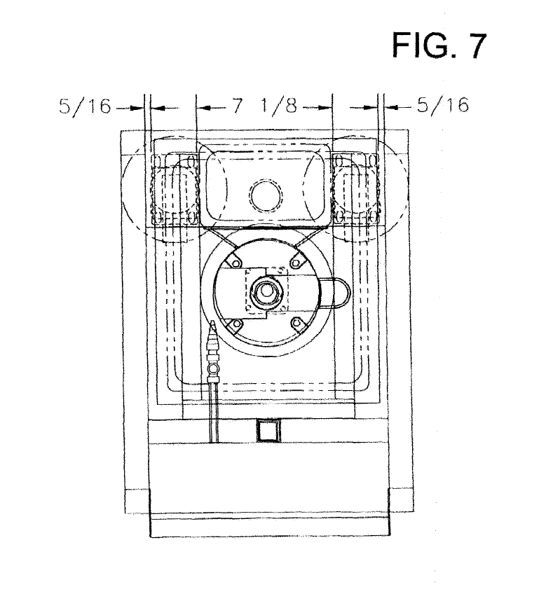

FIG. 5 shows the filtering section 18a in the same position as in FIG. 2. However, this shows the support member in its more retracted position. FIG. 7 illustrates the centrifugal filtering unit 18a at its most retracted and stowed position. Thus, there are approximately 10-inches of play where the support for the centrifugal filtering unit 18a has about 10-inches of adjustment.

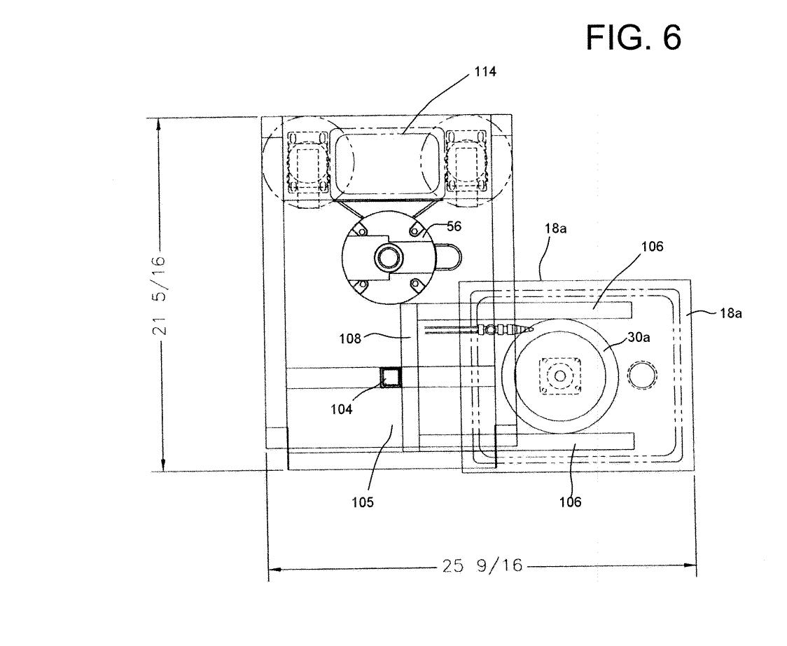

FIG. 6 is a top plan view of the apparatus with the filtering section 18a in a more retracted position.

FIG. 7 is a plan view of the apparatus which shows essentially the same components as in FIG. 6. However, FIG. 7 differs in that the filtering section 18a has been rotated 90° to the stowed position of FIG. 7. This is accomplished by lifting the U-shaped support member upwardly so that the support sleeve 104 slides upwardly and off the post 102. Then the entire assembly with the filtering section 18a being rotated around 90° so that the support sleeve 104 is aligned with the post 102, and the filter section 18a is lowered into its stowed position with a relatively small footprint.

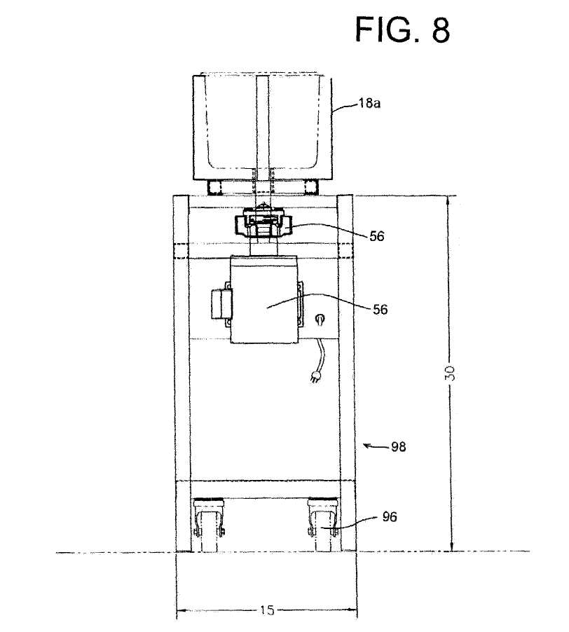

FIG. 8 is taken from the same view location as FIG. 5 and is the same as FIG. 5 except that the filtering section 18a has been rotated 90° to be in the stowed position shown in FIG. 8.

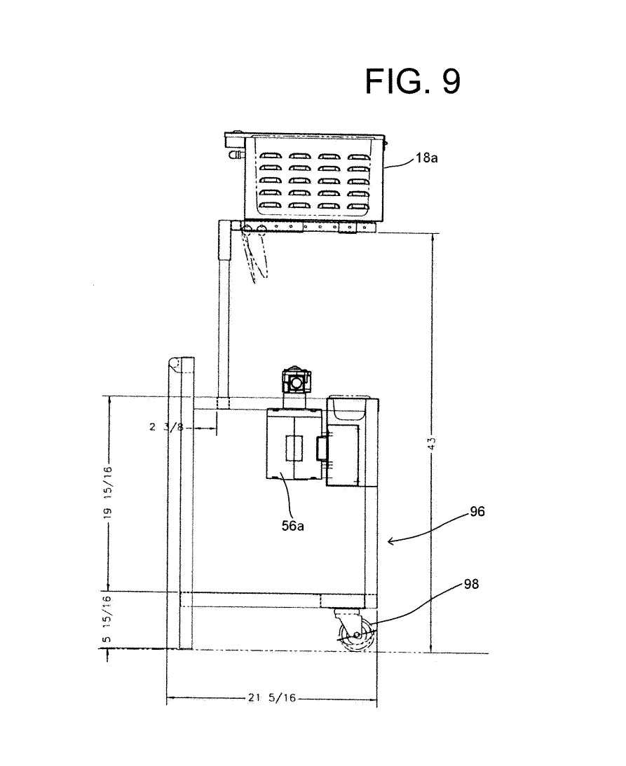

FIG. 9 also shows the cart 96, except that FIG. 9 is a side view of the cart. Also, the filtering section 18a has been raised to its maximum height.

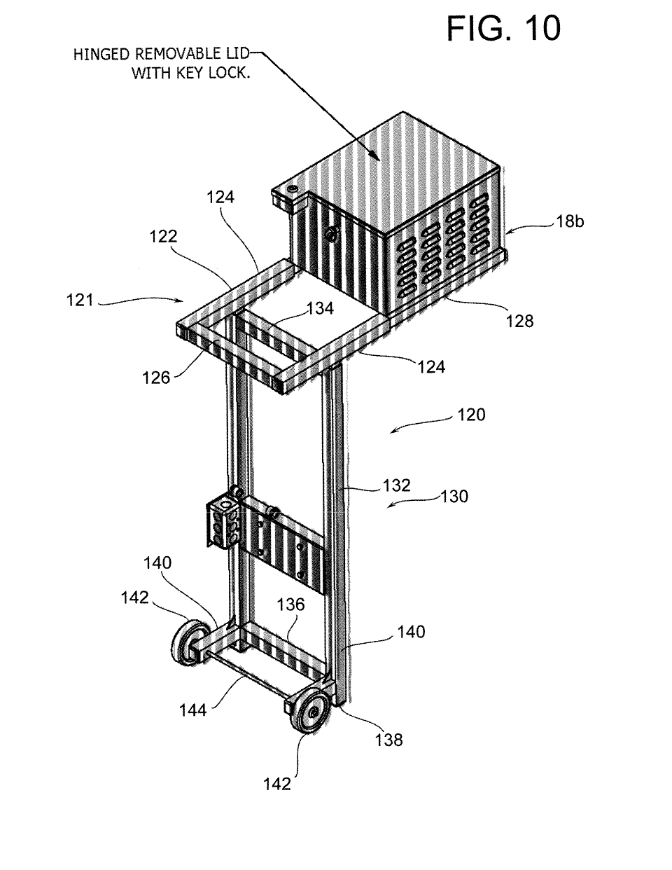

Let us move now to consider the third embodiment 120 of the present invention, shown in FIGS. 10 through 16. The components of this third embodiment which are the same as, or similar to, the first embodiment will be like numerical designations with a “b” suffix distinguishing those of this third embodiment.

Reference is first made to FIG. 10 which is an isometric drawing showing the filtering section 18b. It is to be understood that this third embodiment has a supply and retaining section 50b such as shown at 50 in the earlier embodiments. Also, it is evident that the very same system, as shown in the earlier two embodiments, could be used in this third embodiment. For ease of illustration, the supply and returning section of this third embodiment will not be shown in FIGS. 10 through 16 that are directed toward the third embodiment.

With further reference to FIG. 10, there is a mobile transporting section 120 which, in terms of structure and how it is used, is quite similar to an everyday hand truck where there is an elongate structure having an upper portion that is grasped, and the bottom wheels which provide the ground support.

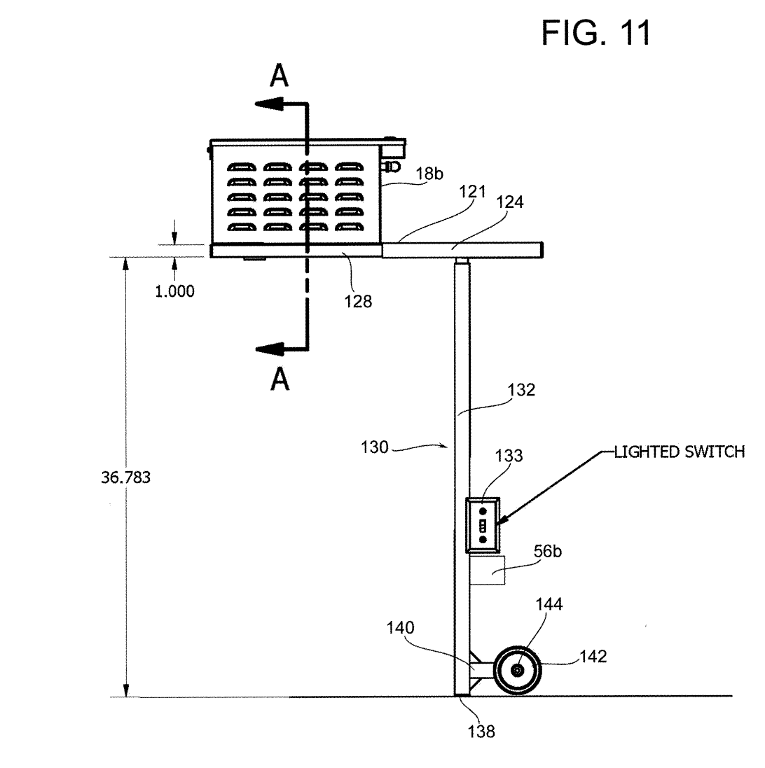

There is also an upper filter section support portion 121, which comprises a U-shaped platform 122 made up of two horizontal arms 124 and a base cross-member 126. The two arms 124 are formed with a hollow interior and are actually outer telescoping members so that each has a telescoping extension member 128 (see FIG. 11).

The transporting section 120 can be considered as having a vertical support section 130 which comprises two vertically aligned posts 132 which are spaced laterally from one another. There are upper and lower cross-members 134 and 136. The upper ends of the two posts 132 connect to the arms 124 of the U-shaped platform 122. Also at the upper ends there is an upper cross-member 134 between the upper ends of the two posts 132. The two posts 132 have lower end surface portions 138 which are made of a sufficiently durable material to function as ground or floor engaging members.

Also, as can be seen in both FIGS. 10 and 11, there is at the bottom part of each of the two posts 132 a rearwardly extending support arm 140 which has a forward end fixedly connected to its related posts 132 and which connects at its rear end to a related wheel 142. There is an axle 144 reaching between the two wheels 142 which are rotatably mounted to the outer ends of the axle 144.

In FIG. 11, there is shown a motor 56b that is mounted between the two vertical posts 132. This motor 56b serves the very same function as discussed in the earlier embodiments, so that will not be repeated in this portion of the text. However, in this third embodiment, this motor 56b does serve a worthwhile function beyond supplying power to the pump and other components of the system. It will be noted that in a front to rear position framework the center of gravity of the motor 56b is positioned between the bottom ground engaging surface 138 and between a center axes 146 of the two wheels 142. It may be desired for the person who is using this apparatus to have the mobile transporting section 120 by itself remain at an upright stationary position. If the center of gravity is between the ground engaging surfaces 138 and the center of axis 146 of the wheels 142, then the transporting section would be in balance and would remain in the upright stationary position. Further, if the filtering section 18b is on the support member 121, this would possibly be accomplished by moving the filter section 18b to its rear most position as shown.

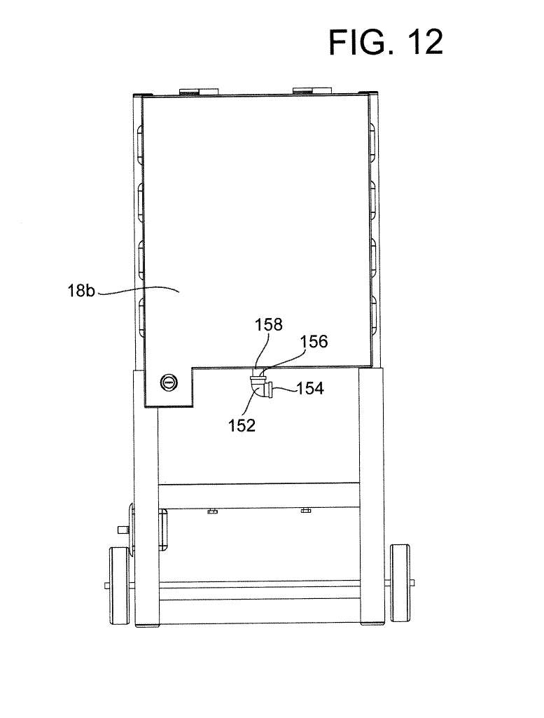

FIG. 12 is simply a top plan view of the assembly. There is shown a plumbing component in the form of an elbow 152 which has an outside connection 154 which would connect to one of the outside hoses, and an inside connection 156 which is shown connecting the fitting 152 to an end portion of a pipe or conduit 158 that is part of the supply and return section of this third embodiment.

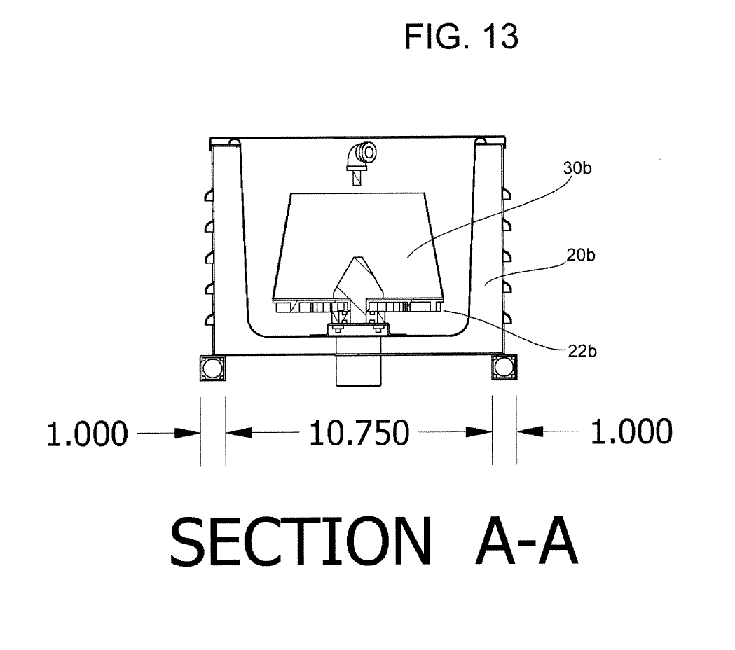

FIG. 13 is a sectional view taken at A-A of the filtering section 18b of FIG. 11. This shows the centrifuge filter 30b. In this view, there is also shown the housing 20b and the chamber 22b.

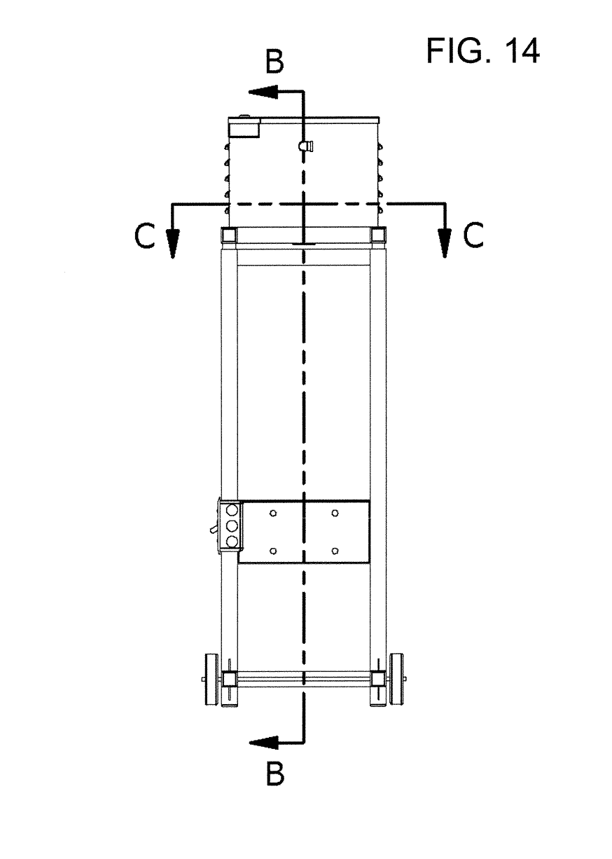

FIG. 14 is a rear elevational view of the entire third embodiment.

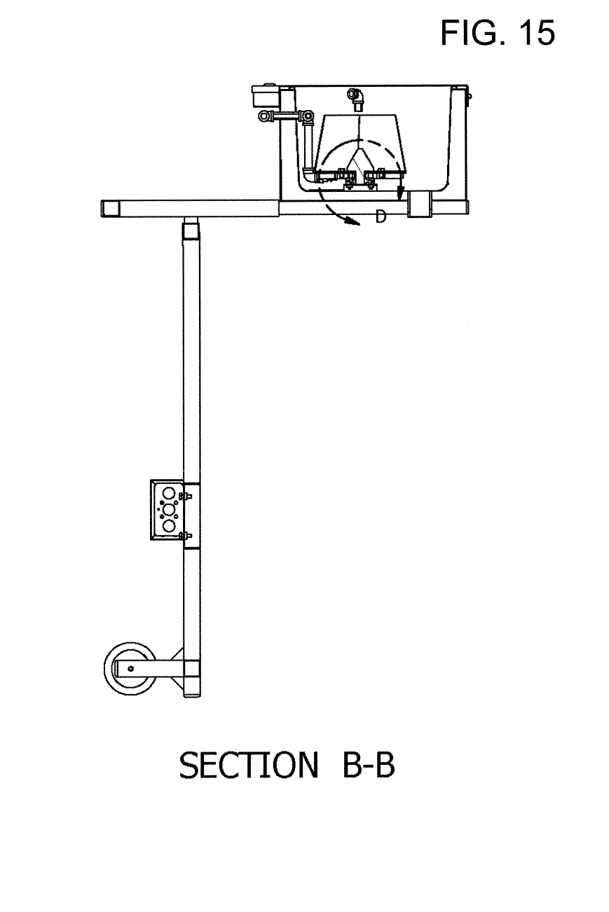

FIG. 15 is a sectional view taken at B-B of FIG. 14, and this illustrates the support frame.

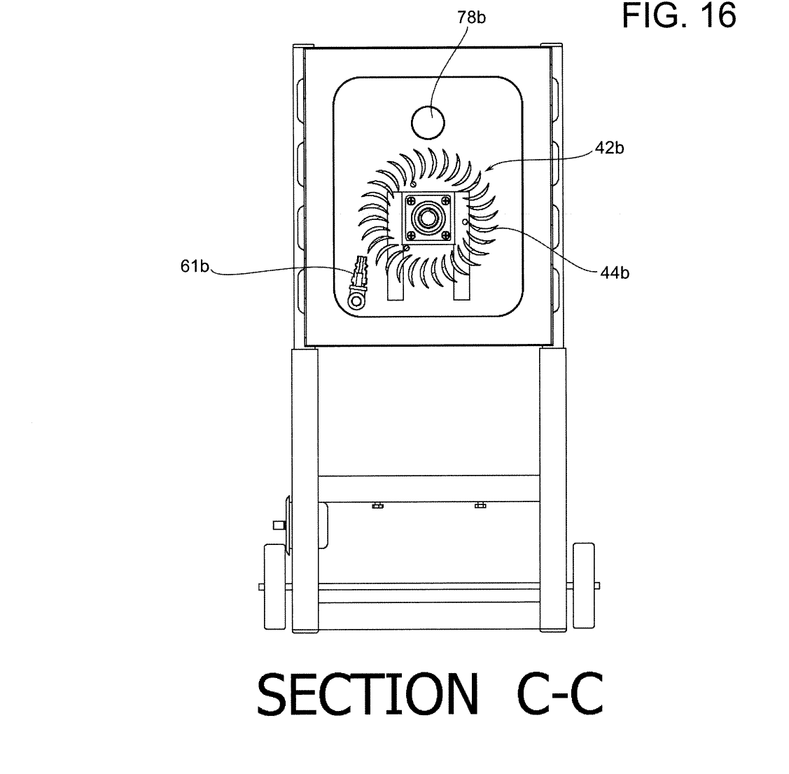

FIG. 16 is a sectional view taken along C-C of FIG. 14, and showing portions of the centrifugal filter, and more specifically showing the turbine 42b of the centrifugal filter 30b.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A portable filtering assembly which is adapted to be placed in proximity to a source of cooking oil and be placed in operative engagement with said source of cooking oil, followed by removing cooking oil from the source of oil to a filtering location to be filtered and returning the filtered oil to said source of cooking oil, this being done in a manner that the portable assembly can conveniently be moved to another location where there is a source of cooking oil to be filtered, said assembly comprising:
a. a centrifugal oil filtering section comprising:
i. a centrifugal filter housing defining a substantially closed filtering chamber;
ii. a centrifugal oil filter comprising a surrounding filtering sidewall and a centrifugal filter oil inlet;
b. an oil supply section comprising;
i. a pump section comprising at least one pump and further comprising an oil supply pump section inlet and an oil supply pump section outlet;
ii. a pump inflow section having a path or conduit having an inlet capable of being placed in a position to withdraw oil from the cooking oil source to flow into said pump inflow section and to said oil supply pump section let;
iii. a pump outflow conduit having a pump outflow conduit inlet which connects to said supply pump output to deliver cooking oil to said centrifugal filtering section with at least a portion of the cooking oil from the pump which is directed into the centrifuge to be filtered;
c. an oil return section into which at least a significant portion of the oil which has been pumped into the centrifugal oil filtering section is directed to be returned to the source of cooking oil as filtered cooking oil.

2. The apparatus as recited in claim 1, wherein the centrifugal oil filter section has a vertical axis of rotation and a downwardly extending rotatable drive member that connects to, and is rotatably driven by, a motor section that also drives the pump section.

3. The apparatus as recited in claim 1, wherein the centrifugal oil filter section is rotatably driven by a turbine connected to the centrifugal oil filter, and the turbine is powered by a portion of the cooking oil in the pump outflow conduit that is directed to drive said turbine.

4. The apparatus as recited in claim 3, wherein said pump conduit is arranged to separate into first and second branches, with the first branch driving the turbine and where the second branch connects discharges oil to the upper opening of the centrifugal filter.

5. The apparatus as recited in claim 1, wherein said pump inflow conduit has an inlet end portion that comprises an at least moderately stiff intake member that could dislodge and suck in debris, such as food particles in the source of oil and an at least moderately stiff hand engaging portion.

6. The apparatus as recited in claim 1, wherein said centrifugal oil filter section comprises an outer perforate sidewall and a removeable filter.

7. The apparatus as recited in claim 1, wherein there is a mobile support structure having at least two wheels at one end of the structure and having a ground support portion at an opposite end of the structure, the filtering section being positioned on a platform that is in turn mounted to an adjustable support section so that the platform can be moved about a vertical center of rotation to a forward location or side location.

8. The apparatus as recited in claim 1, wherein there is a mobile support structure having at least two wheels at one end of the structure and having a ground support portion at an opposite end of the structure, the filtering section being positioned on a platform that is in turn mounted to an adjustable support section so that the platform can be moved rotatably about a vertical center of rotation, said center of rotation being at one end of the support structure in a manner that the platform can be rotated 180° to be positioned directly over the support structure to be in a stowed position where the footprint is at a minimum.

9. The apparatus as recited in claim 1, wherein there is a mobile support structure having at least two wheels and there is a single vertical support structure comprising two laterally spaced posts extending substantially vertically from a ground location to an upper juncture location at which there is a forwardly extending support platform which supports the centrifugal oil filtering section, and there is a telescoping platform extension to move the centrifugal oil filtering section from a retracted location directly above the vertical support section to a forward location spaced beyond vertical support section.

10. The apparatus as recited in claim 9, wherein the two wheels are spaced rearwardly of the lower end of the vertical support section, so that when the telescoping platform is at a full retracted position the center of gravity of the centrifugal oil filtering section is between the ground engaging bottom ends of the two posts and the wheels so that the support structure functions as a vertical stable support.

11. A method of filtering cooking oil that is in a source of cooking oil, such as a reservoir of cooking oil in a restaurant or cafe, in a manner that the oil is in large part not exposed to the outside environment, except for the exposure it might have in the restaurant or cafe, and in a manner so that equipment that used in filtering the cooking oil is capable of being moved easily to other locations where cooking oil could be filtered, said method comprising:
a. providing a housing that has a substantially enclosed chamber and positioning a centrifugal filter in said chamber;
b. providing a conduit section and positioning an inflow end portion of the conduit section in operative engagement with oil in the source of cooking oil and positioning an outlet end portion of the conduit section in operative engagement in the chamber with the centrifugal filter;
c. utilizing a pump section with the conduit section to draw cooking oil in from the source of oil to be delivered by the conduit section into the chamber and into an inlet of the centrifugal filter;
d. rotating the centrifugal filter as the cooking oil is fed into the centrifugal filter to produce filtered cooking oil; and
e. removing the filtered oil from the chamber and directing the filtered oil back to the source of the cooking oil.

12. The method as recited in claim in 11, further comprising rotating the centrifugal filter section by first attaching a turbine to the centrifugal filter so that a center of rotation of the turbine is aligned with the axis of rotation of the centrifugal filter, and directing a portion of the cooking oil under pressure into the chamber to engage the turbine and cause the turbine with the centrifugal filter to rotate together.

13. The method as recited in claim 12, comprising directing the flow of the cooking oil through the chamber in a manner so that the cooking oil separates to flow in first and second branches, with the first branch driving the turbine and the second branch connecting to an adjustable outlet to be able to direct the oil into the centrifugal filter.

14. The method as recited in claim 11, further comprising providing an inlet end portion of the conduit section that is in contact with the oil has an intake member that is at least moderately stiff and utilizing this moderately stiff intake member to dislodge and suck in debris, such as food particles in the source of the oil.

15. The method as recited in claim 11, further comprising placing an inner removeable filter within a perforate surrounding sidewall of a centrifugal, and changing said filter periodically and replacing the filter with a fresh filter.

16. The method as recited in claim 11, wherein a task of filtering the cooking oil in the source of the cooking is accomplished in a situation where a location of the source of cooking oil is at a location that is difficult to reach, and providing a mobile support structure having wheels at one end of the structure and having a support portion at the opposite end of the structure, said method further comprising supporting the housing and the conduit section on a platform that can be raised and lowered, and is also mounted on a support that can be rotated to different locations and facing in different directions, said method further comprising either raising or lowering and/or moving the housing to an appropriate operating location.

17. The method as recited in claim 11, wherein if the task of filtering the cooking oil in the source of the cooking is to be accomplished in a situation where the location of the source of cooking oil is at a location that is difficult to reach, said method is to provide a mobile support structure having wheels at one end of the structure and a support portion at the opposite end of the structure, said method further comprises supporting a housing and the conduit section on a platform that can be raised and lowered, and is also mounted on a support that can be rotated to different locations and facing in different directions, said method further comprising either raising or lowering and/or moving the housing to an appropriate operating location,.

18. The method as recited in claim 11, wherein said method further comprises providing a center of rotation of said support section to be at one end of the support structure, and for stowage the platform is rotated 180° from a forward position directly over the support structure so as to be in a stowed position where the footprint is at a minimum.

19. The method as recited in claim 11, wherein a situation is sometimes met where the source of cooking oil is at a location which is rather cramped, and any equipment must have a relatively small footprint relative to the area it occupies at any one time, said method comprising providing a mobile support structure having at least two wheels and a single vertical support structure comprising at least two laterally spaced posts that and standing substantially vertically from a ground location to an upper juncture location where there is a forwardly extending support platform, said method comprising providing not only the extending support platform, but also providing a telescoping platform section, said method further comprising placing the filtering section on the platform and extending the platform and extending the platform to its maximum length so that it is properly positioned relative to the source of cooking oil, or retracting the telescoping platform extension so the wheel support itself could be moved further forward to a desired location.

20. The method as recited in claim 19, wherein it is also recognized that there are some instances where the mobile support structure is desired to have a rest position where it is still in an upright position so as to be vertically aligned, said method further comprising retracting the platform with the centrifugal filter section is moved to its fully retracted rear position so that the center of gravity is between the two wheels and the two lower ends of the two post members of the vertical support structure, so that the support structure is at an erect rest position.
